(19) United States
(12) Patent Application Publication
(10) Pub. No.: US 2025/0360860 A1
(43) Pub. Date: Nov. 27, 2025

(54) PULLABLE-FOLDABLE COMBINED REAR EXPANSION STRUCTURE FOR RECREATIONAL VEHICLES

(71) Applicant: RONGCHENG COMPAKS NEW ENERGY AUTOMOBILE CO., LTD, Weihai City (CN)

(72) Inventors: Qiming CHEN, Weihai City (CN); Jianjun CHEN, Weihai City (CN); Shilei WANG, Weihai City (CN); Shaoxun LIU, Weihai City (CN); Chuanjie WANG, Weihai City (CN); Peng ZHANG, Weihai City (CN)

(21) Appl. No.: 18/995,111

(22) PCT Filed: Apr. 3, 2024
(86) PCT No.: PCT/CN2024/085726

§ 371 Date: Jan. 15, 2025

(30) Foreign Application Priority Data
Jan. 12, 2024 (CN) 202410046381.0

(51) Int. Cl. B60P 3/34

(52) U.S. Cl. CPC B60P 3/34

(57) ABSTRACT

A pullable-foldable combined rear expansion structure includes side plates, a rear plate, bottom plates, a top plate, and a guide rail. The side plates includes left and right side plates. The left side plate and the right side plate are connected to the rear plate to form a rigid frame. The bottom plates include a front bottom plate and a rear bottom plate. A front end of the front bottom plate is rotatably connected to a bottom of a compartment. A rear end of the front bottom plate is rotatably connected to a front end of the rear bottom plate. A rear end of the rear bottom plate is rotatably connected to the frame. The frame is connected to the compartment through the guide rail, the top plate is at an outer side of the frame, and an upper end of the top plate is rotatably connected to the compartment.

### CROSS-REFERENCE TO RELATED APPLICATIONS

The present disclosure claims the priority to Chinese Patent Application No. 202410046381.0, filed with the Chinese Patent Office on Jan. 12, 2024 and entitled “PULLABLE-FOLDABLE COMBINED REAR EXPANSION STRUCTURE FOR RECREATIONAL VEHICLES”, which is incorporated in its entirety herein by reference.

### BACKGROUND OF THE PRESENT INVENTION

### Field of Invention

The present disclosure relates to an expansion structure for recreational vehicles, and in particular to a pullable-foldable combined rear expansion structure for recreational vehicles.

### Description of Related Arts

At present, with an increasing demand for recreational vehicles in the global market, large-space and full-featured motorhomes and trailers are favored by users increasingly. An ideal recreational vehicle must offer comfortable driving performance while in motion, and ample use space when stationary. Thus, efficient utilization of interior space and expansion of the interior space by various means are critical considerations in layout design of the recreational vehicles. Rear expansion is a common practice to achieving this through either pullable or foldable structures traditionally.

The common pullable structure solution is available in Chinese Patents CN 202144223 U, CN 113799678 A, etc. As described in CN 202144223 U, an electric motor drives a rack-pinion mechanism through a reduction mechanism (a belt pulley), enabling an expansion box fixedly connected to a rack to move telescopically along a guide rail. Although telescopic expansion can be realized conveniently through the electric motor of such a structure, drawbacks still exist such as large interior space occupation, structural complexity, high costs, and challenges in water prevention and sealing at a joint between the expansion box and the compartment. CN 113799678 A employs a connecting rod mechanism connected to the expansion box to balance forces during extension, resulting in complex structure. Moreover, large interior space occupation, difficult water prevention and sealing at the joint between the expansion box and the compartment, etc. are still to be solved.

The common foldable structure solution is available in Chinese Patents CN 109109727 A, CN 105966299 B, etc. According to CN 109109727 A previously applied by the applicant, a rear expansion box is set up by turning over a top plate, side plates, a bottom plate frame, and a rear plate in sequence. While the structure is simple advantageously, the operation is complicated, large interior space is occupied when the structure is folded, and great manual efforts are required. As described in CN 105966299 B, side plates are designed into foldable structures, and a guide rail is arranged on a first movable plate. When an expansion box is unfolded, the first movable plate is firstly turned over, a third movable plate and the side plates are then unfolded under the action of linkage, followed by turning over a second movable plate. Accordingly, small space is occupied when the structure is folded, and the operation is relatively easy. However, this mechanism features a complex structure, lower reliability, and an inclusion of two hinge joints on each side plate, making it difficult to realize waterproofing, sound insulation, and heat insulation.

In conclusion, it is a pressing issue to develop a novel rear expansion structure for recreational vehicles, so as to solve the above technical problems.

### SUMMARY OF THE PRESENT INVENTION

In view of the above, the present disclosure provides a pullable-foldable combined rear expansion structure for recreational vehicles, so as to at least solve some problems in the prior art. To realize the above objective, the technical solution employed in the present disclosure is as follows:

A pullable-foldable combined rear expansion structure for recreational vehicles includes side plates, a rear plate, bottom plates, a top plate, and a guide rail, where the side plates include a left side plate and a right side plate, and the left side plate and the right side plate are connected to the rear plate, so as to form a rigid frame; the bottom plates include a front bottom plate and a rear bottom plate, a front end of the front bottom plate is rotatably connected to a bottom of a compartment, a rear end of the front bottom plate is rotatably connected to a front end of the rear bottom plate, and a rear end of the rear bottom plate is rotatably connected to the frame; and the frame is connected to the compartment through the guide rail, the top plate is positioned at an outer side of the frame, and an upper end of the top plate is rotatably connected to a top of the compartment.

Furthermore, the guide rails include a static guide rail and a movable guide rail, where the static guide rail is fixed to the compartment, while the movable guide rail is fixed to the frame and moves relative to the static guide rail, so that stretch and retraction of the frame are realized.

Furthermore, the movable guide rails include bottoms of the side plates and overhanging portions extending along the bottoms of the side plates, i.e. a first movable guide rail and a second movable guide rail; and the static guide rails are fixed to the bottom of the compartment, and include a first static guide rail and a second static guide rail that are positioned at two sides, and upper portions of the first static guide rail and the second static guide rail are provided with openings allowing the side plates to pass therethrough.

Furthermore, upper sides of front portions of the left side plate and the right side plate are provided with extension portions, i.e. a first extension portion and a second extension portion that protrude upwards from the side plates; and the first extension portion and the second extension portion abut against corresponding structures in the compartment in a case that the frame stretches out to an external limit position.

Furthermore, the movable guide rails further include a middle movable guide rail positioned between the first movable guide rail and the second movable guide rail, and the middle movable guide rail is connected to a bottom of the rear plate; and the static guide rails further include a middle static guide rail positioned between the first static guide rail and the second static guide rail, and the middle static guide rail cooperates with the middle movable guide rail.

Furthermore, two middle movable guide rails, i.e. a third movable guide rail and a fourth movable guide rail are provided, and two middle static guide rails, i.e. a third static guide rail and a fourth static guide rail are provided.

Furthermore, the movable guide rails and the static guide rails are of square-tube structures, and upper portions of the square-tube structures of the first static guide rail and the second static guide rail are provided with the openings.

Furthermore, rollers are mounted at end portions, away from the frame, of the movable guide rails, the rollers on the movable guide rails are in contact and cooperation with internal upper surfaces of the static guide rails, the compartment is provided with rollers below the movable guide rails, and external lower surfaces of the movable guide rails are in contact and cooperation with the rollers mounted on the compartment when the movable guide rails stretch or retract.

Furthermore, a first connector is arranged at a position, close to the rear plate, of a bottom of the frame, and the first connector is connected to the first movable guide rail, the second movable guide rail, the third movable guide rail, and the fourth movable guide rail; and the static guide rails include a second connector close to a rear portion of the compartment, and the second connector is connected to the first static guide rail, the second static guide rail, the third static guide rail, and the fourth static guide rail.

Furthermore, the front bottom plate and the rear bottom plate, the front bottom plate and the compartment, as well as the rear bottom plate and the frame are rotatably connected to each other through hinges respectively.

Furthermore, one side of the hinge connecting the rear bottom plate and the frame is mounted on an upper surface of the first connector, and the other side is mounted on a rear end surface of the rear bottom plate; and one side of the hinge connecting the front bottom plate and the compartment is mounted on an upper surface of the second connector, and the other side is mounted on a front end surface of the front bottom plate.

Furthermore, the static guide rails further include a third connector arranged parallel to the second connector, and the third connector is connected to the first static guide rail, the second static guide rail, the third static guide rail, and the fourth static guide rail.

As a preferred embodiment, a first handle is provided at a position, close to the rear bottom plate, of a middle of the front bottom plate, and a window and a second handle are provided at a middle and an upper portion of the rear plate respectively.

As a further preference, the first handle is hidden.

As a preferred embodiment, upper portions of the left side plate and the right side plate are configured as of inclined structures relative to a horizontal plane, and upper sides of rear portions of the left side plate and the right side plate are provided with extension portions, i.e. a third extension portion and a fourth extension portion that protrude backwards from the side plates respectively; and the third extension portion and the fourth extension portion are provided with rolling portions respectively, and the rolling portions make contact with the top plate in a case that the frame stretches or retracts relative to the compartment.

As a further preference, the top plate is provided with outward protrusion portions accommodating upper portions of the rolling portions in a case that the frame stretches to a limit position relative to the compartment.

As a further preference, an inner side of the top plate is provided with a sealing portion, and an upper portion of the rear plate is further provided with a location pin; and the sealing portion covers an outer edge of an upper portion of the frame, and the location pin penetrates a corresponding hole on the sealing portion in a case that the frame stretches to a limit position relative to the compartment.

As a preferred embodiment, the top plate is rotatably connected to the compartment through an adapter plate including parallel planes at two ends and a connecting plane in a middle. One end of the adapter plate is fixedly connected to a rear portion of the compartment, and the other end is connected to an outward flange at the upper end of the top plate through a hinge.

As a preferred embodiment, front portions of the left side plate and the right side plate are provided with outward flanges, and a left end, a right end, and a lower end of the top plate are provided with inward flanges.

Compared with the prior art, the present disclosure has significant advantages as follows:
1. The advantages of both pullable and foldable structures are combined, the side plates and the rear plate are of integrated pullable structures, while the bottom plates and the top plate are of foldable turnover structures. When folded, such design minimizes interior space occupation. Rear expansion can be achieved simply by pushing the handle on the rear plate through the one-step operation. And the entire structure can be retracted by pulling the handle on the bottom plate, followed by pulling the handle on the rear plate to draw it into the compartment. Therefore, the operation is very convenient.
2. The two bottom plates are designed into a foldable structure. When unfolded, they are flattened, securing the rear expansion structure at its maximum extension. During retraction, the position of the handle on the front bottom plate, close to a foldable hinge, allows for easy pulling with minimal effort. In addition, the two bottom plates can assist the guide rails in guiding during both folding and unfolding processes.
3. The fully integrated side and rear plates offer desirable waterproofing, sound insulation, and heat insulation. And the rear expansion portion is sealed with respect to the outside throughout the folding and unfolding processes, so as to effectively prevent the entry of external dust and mosquitoes.
4. The hinge connecting the top plate and the box is displaced to the adapter plate, so that rainwater can be effectively prevented from pouring into the compartment from the hinge joint of the top plate. Additionally, the rolling portions on the two side plates=can reduce friction between the top plate and the side plates while preventing scratches.

### BRIEF DESCRIPTION OF THE DRAWINGS

FIG. 1 is a schematic diagram of a partial structure of the present disclosure mounted on a compartment when unfolded (in a front view);

FIG. 2 is a schematic diagram of a partial structure of the present disclosure mounted on a compartment when unfolded (in a rear view);

FIG. 3 is a schematic diagram of a partial structure of the present disclosure mounted on a compartment when folded (in a front view);

FIG. 4 is a schematic diagram of a partial structure of the present disclosure mounted on a compartment when unfolded (in a rear view);

FIG. 5 is a schematic structural diagram of a partial connection between a rear bottom plate and a frame according to the present disclosure;

FIG. 6 is a schematic structural diagram of a partial connection between a front bottom plate and a compartment according to the present disclosure;

FIG. 7 is a schematic structural diagram of a frame formed by side plates (with a skin on a right side plate omitted) and a rear plate according to the present disclosure;

FIG. 8 is a partial enlarged view of portion A in FIG. 7;

FIG. 9 is a partial enlarged view of portion B in FIG. 7;

FIG. 10 is a partial enlarged view of portion C in FIG. 7;

FIG. 11 is a schematic structural diagram of partial cooperation between a frame and a top plate when the present disclosure is unfolded;

FIG. 12 is a schematic structural diagram of a top plate according to the present disclosure;

FIG. 13 is a schematic structural diagram of a partial joint between a top plate and a compartment according to the present disclosure;

FIG. 14 is a schematic structural diagram of the present disclosure mounted on a compartment when unfolded; and

FIG. 15 is a front view of the present disclosure mounted on a compartment when unfolded.

### DETAILED DESCRIPTION OF THE PREFERRED EMBODIMENT

Examples of the present disclosure are described in detail below and illustratively shown in the accompanying drawings. The same or similar reference numerals denote the same or similar elements or elements having the same or similar functions throughout. The examples described below with reference to the accompanying drawings are illustrative and are intended to explain the present disclosure, but cannot be interpreted as limiting the present disclosure.

The present disclosure will be described in detail below with reference to the accompanying drawings and specific examples.

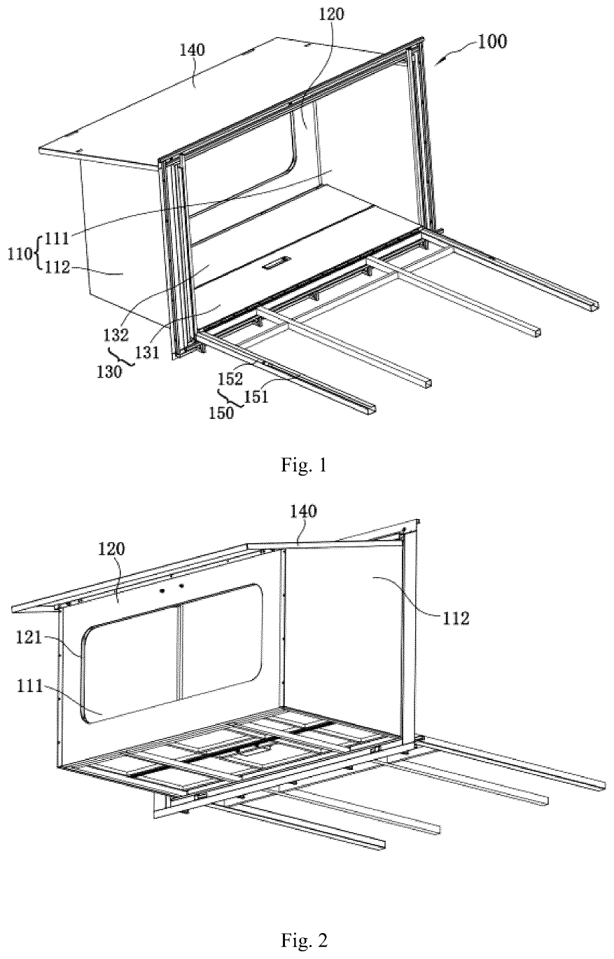

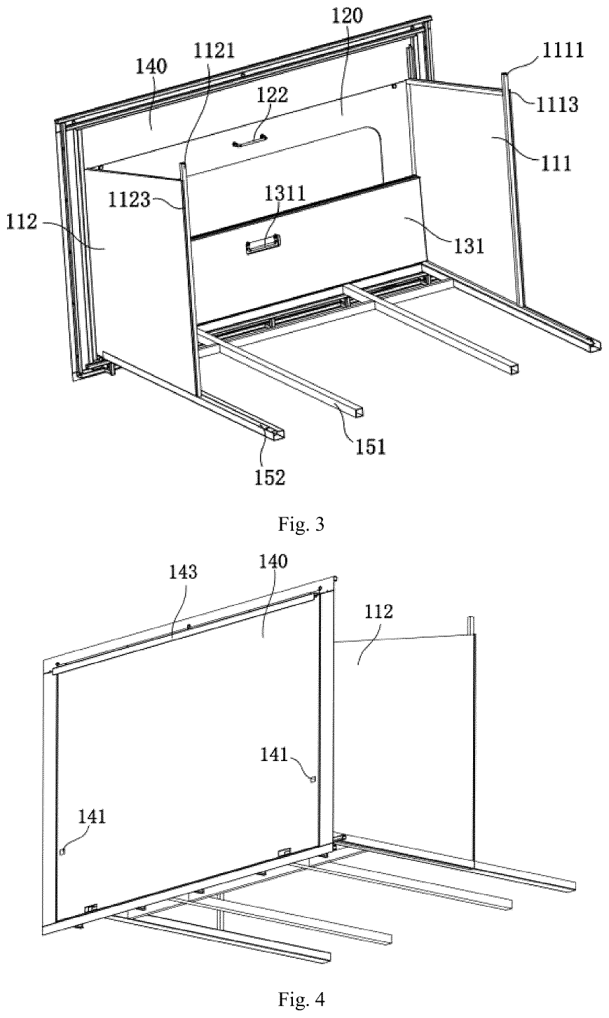

As shown in FIGS. 1-4 and 7, a pullable-foldable combined rear expansion structure 100 for recreational vehicles includes side plates 110, a rear plate 120, bottom plates 130, a top plate 140, and a guide rail 150, where the side plates 110 include a left side plate 111 and a right side plate 112, and the left side plate 111 and the right side plate 112 are connected to the rear plate 120, so as to form a rigid frame; the bottom plates 130 include a front bottom plate 131 and a rear bottom plate 132, a front end of the front bottom plate 131 is rotatably connected to a bottom of a compartment 200, a rear end of the front bottom plate 131 is rotatably connected to a front end of the rear bottom plate 132, and a rear end of the rear bottom plate 132 is rotatably connected to the frame; and the frame is connected to the compartment 200 through the guide rail 150, the top plate 140 is positioned at an outer side of the frame, and an upper end of the top plate 140 is rotatably connected to a top of the compartment 200.

The guide rails 150 include a static guide rail 151 and a movable guide rail 152, where the static guide rail 151 is fixed to the compartment 200. It should be noted that in order to highlight the core technical solution of the present disclosure, only part of the compartment 200 is illustratively drawn, and a structure is simplified. The movable guide rail 152 is fixed to the frame and moves relative to the static guide rail 151, so that stretch and retraction of the frame are realized.

Furthermore, outer peripheries of the left side plate 111 and the right side plate 112 are welded through square tubes. The movable guide rails 152 include bottoms of the left side plate 111 and the right side plate 112, and overhanging portions extending along the bottoms of the left side plate 111 and the right side plate 112, i.e. a first movable guide rail 1521 and a second movable guide rail 1522; and the static guide rails 151 are fixed to the bottom of the compartment 200, and include a first static guide rail 1511 and a second static guide rail 1512 that are positioned at two sides, and upper portions of the first static guide rail 1511 and the second static guide rail 1512 are provided with openings 1511a, 1512a allowing the side plates to pass therethrough.

Furthermore, upper sides of front portions of the left side plate 111 and the right side plate 112 are provided with extension portions, i.e. a first extension portion 1111 and a second extension portion 1121 that protrude upwards from the side plates 110; and the first extension portion 1111 and the second extension portion 1121 abut against corresponding structures in the compartment 200 in a case that the frame stretches out to an external limit position. In this case, the majority of the moment for turning an entire rear expansion structure outwards is borne by the corresponding structures in the compartment, with the minority borne by the static guide rails.

Furthermore, the movable guide rails 152 further include a middle movable guide rail positioned between the first movable guide rail 1521 and the second movable guide rail 1522, and the middle movable guide rail is connected to a bottom of the rear plate 120; and the static guide rails 151 further include a middle static guide rail positioned between the first static guide rail 1511 and the second static guide rail 1512, and the middle static guide rail cooperates with the middle movable guide rail.

As a preferred embodiment, two middle movable guide rails, i.e. a third movable guide rail 1523 and a fourth movable guide rail 1524 are provided, and two middle static guide rails, i.e. a third static guide rail 1513 and a fourth static guide rail 1514 are provided. The arrangement of these guide rails enables smoother pulling movement smoother and more reasonable force distribution.

As a further preference, the movable guide rails 152 and the static guide rails 151 are of square-tube structures, and upper portions of the square-tube structures of the first static guide rail 1511 and the second static guide rail 1512 are provided with the openings 1511a, 1512a. The static guide rails and the movable guide rails are made of aluminum alloy, so as to achieve weight reduction.

As shown in FIGS. 6 and 8, as a further preference, rollers 160 are mounted at end portions, away from the frame, of the movable guide rails 152, the rollers 160 on the movable guide rails 152 are in contact and cooperation with internal upper surfaces of the static guide rails 151, the compartment 200 is provided with rollers 170 below the movable guide rails 152, and external lower surfaces of the movable guide rails 152 are in contact and cooperation with the rollers 170 mounted on the compartment 200 when the movable guide rails stretch or retract. The arrangement of the rollers transforms sliding friction into rolling friction, and thus a friction force generated when the movable guide rails move is further reduced.

As a preferred embodiment, a first connector 180 is arranged at a position, close to the rear plate 120, of a bottom of the frame, and the first connector 180 is connected to the first movable guide rail 1521, the second movable guide rail 1522, the third movable guide rail 1523, and the fourth movable guide rail 1524, so that the connection among the movable guide rails is further enhanced; and the static guide rails 151 include a second connector 181 close to a rear portion of the compartment 200, and the second connector 181 is connected to the first static guide rail 1511, the second static guide rail 1512, the third static guide rail 1513, and the fourth static guide rail 1514, so that the connection among the static guide rails is further enhanced.

Furthermore, the front bottom plate 131 and the rear bottom plate 132, the front bottom plate 131 and the compartment 200, as well as the rear bottom plate 132 and the frame are rotatably connected to each other through hinges respectively. With such an arrangement, the front bottom plate and the rear bottom plate are unfolded or folded along with stretch or retraction of the frame respectively, so that the operation is simplified.

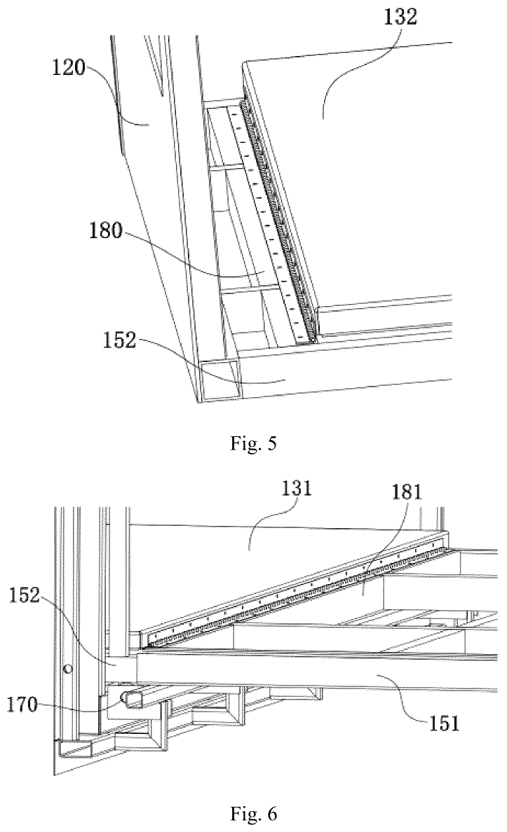

As shown in FIGS. 5 and 6, as a preferred embodiment, one side of the hinge connecting the rear bottom plate 132 and the frame is mounted on an upper surface of the first connector 180, and the other side is mounted on a rear end surface of the rear bottom plate 132; and one side of the hinge connecting the front bottom plate 131 and the compartment 200 is mounted on an upper surface of the second connector 181, and the other side is mounted on a front end surface of the front bottom plate 131.

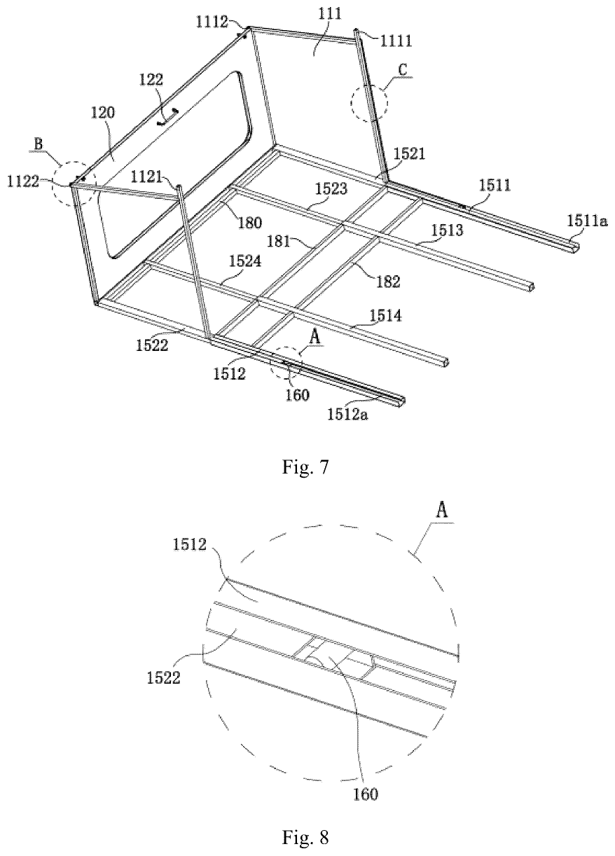

As shown in FIG. 7, as a preferred embodiment, the static guide rails 151 further include a third connector 182 arranged parallel to the second connector 181, and the third connector 182 is connected to the first static guide rail 1511, the second static guide rail 1512, the third static guide rail 1513, and the fourth static guide rail 1514, so that the connection among the static guide rails is further enhanced.

As shown in FIG. 1, as a preferred embodiment, a first handle 1311 is provided at a position, close to the rear bottom plate, of a middle of the front bottom plate 131. According to the force analysis, it can be easy to pull both the front and rear bottom plates while retracting the frame by pulling the first handle 1311. A window 121 and a second handle 122 are provided at a middle and an upper portion of the rear plate 120 respectively. The window 121 is made as large as possible, so as to enrich the scenic viewing experience during travel. The provision of the second handle 122 the pushing and pulling of the entire frame, with both fixed and rotary structures feasible.

As a further preference, the first handle 1311 is hidden, ensuring that the front bottom plate and the rear bottom plate can be positioned on a same plane when unfolded, so that a mattress can be put on the bottom plates conveniently.

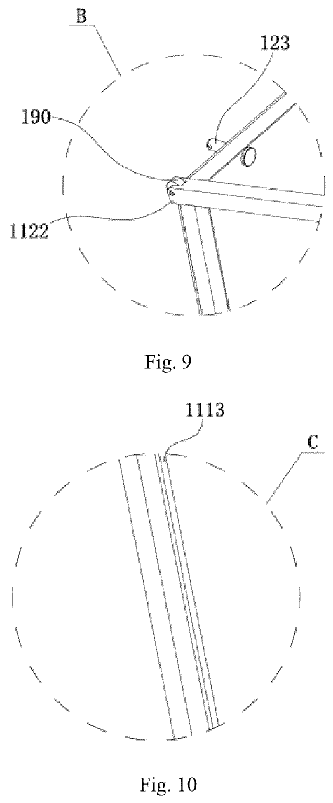

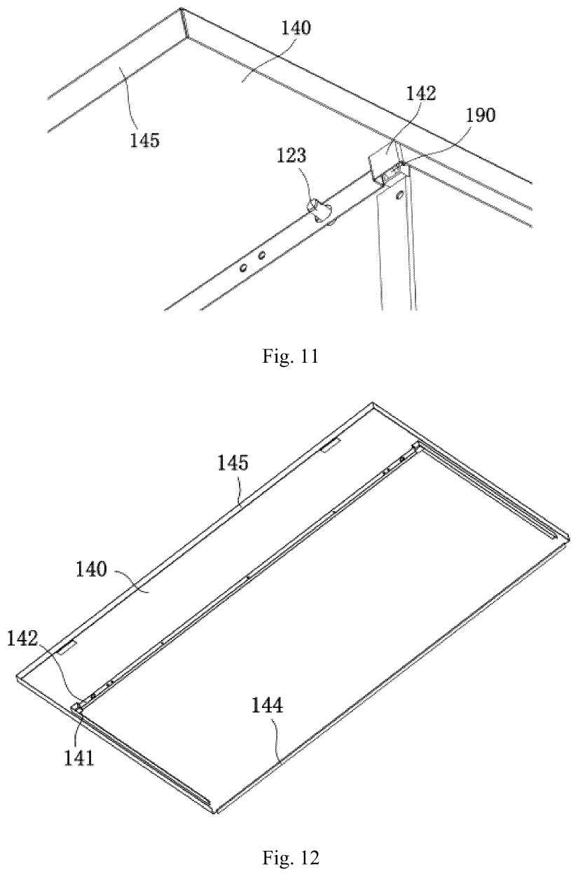

As shown in FIGS. 11, 14, and 15, as a preferred embodiment, upper portions of the left side plate 111 and the right side plate 112 are configured as of inclined structures relative to a horizontal plane. With the inclined structures arranged, the pushing of the top plate is facilitated while ensuring that the top plate is also inclined when unfolded, so as to facilitate rainwater drainage. Moreover, upper sides of rear portions of the left side plate 111 and the right side plate 112 are provided with extension portions, i.e. a third extension portion 1112 and a fourth extension portion 1122 that protrude backwards from the side plates respectively. The third extension portion 1112 and the fourth extension portion 1122 are provided with rolling portions 190 respectively, and the rolling portions 190 make contact with the top plate 140 in a case that the frame stretches or retracts relative to the compartment 200. As shown in FIG. 9, rubber-coated bearings are preferably used as the rolling portions, and upper portions and rear portions of the rolling portions protrude from the third extension portion 1112 and the fourth extension portion 1122 respectively. In addition to the function of guide wheels, the rubber-coated bearings also reduce the friction between the rolling portions and the top plate while preventing scratches.

As shown in FIG. 12, as a preferred embodiment, the top plate 140 is provided with outward protrusion portions 141 accommodating upper portions of the rolling portions 190 in a case that the frame stretches to a limit position relative to the compartment 200. In this way, when the rear expansion structure is unfolded, the top plate is attached to the upper portions of the side plates all the time, so that the sealing performance is ensured.

As a preferred embodiment, an inner side of the top plate 140 is provided with a sealing portion 142, and an upper portion of the rear plate 120 is further provided with location pins 123. Two location pins 123 are preferably provided close to a left side and a right side of the rear plate 120 respectively. The sealing portion 142 covers an outer edge of an upper portion of the frame, and the location pins 123 penetrate corresponding holes on the sealing portion 142 in a case that the frame stretches to a limit position relative to the compartment 200. The sealing portion 142 is used for waterproofing, sound insulation, and heat insulation. The location pins 123 are used for preventing the top plate from being unfolded from the outside, so that the safety is ensured.

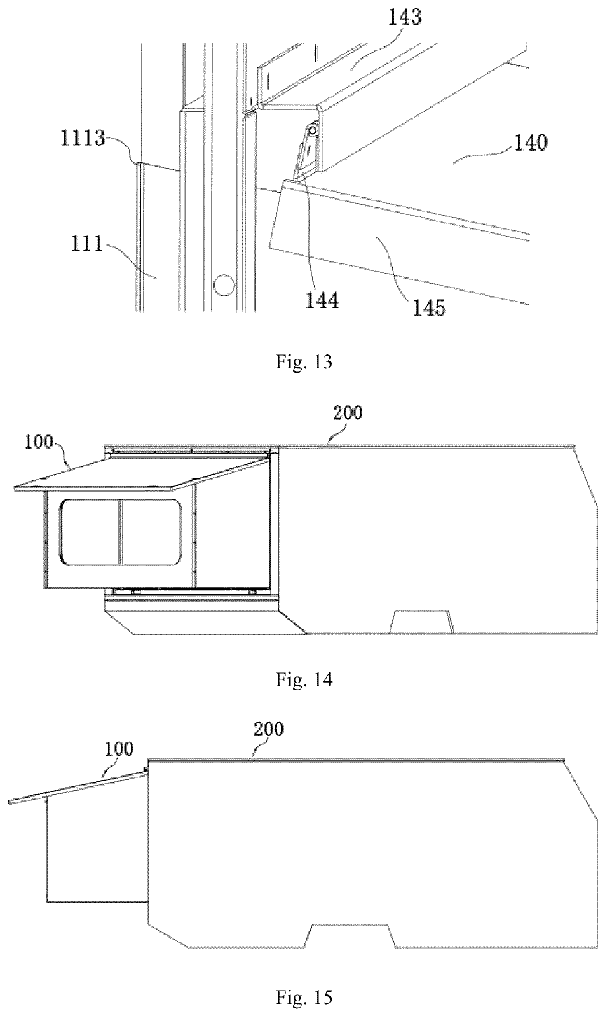

As shown in FIG. 13, as a preferred embodiment, the top plate 140 is rotatably connected to the compartment 200 through an adapter plate 143, including parallel planes at two ends and a connecting plane in a middle. One end of the adapter plate is fixedly connected to a rear portion of the compartment 200, and the other end is connected to an outward flange 144 at the upper end of the top plate 140 through a hinge. With such a structure, rainwater can be effectively prevented from pouring into the compartment from the hinge joint of the top plate.

As shown in FIGS. 10 and 12, as a preferred embodiment, front portions of the left side plate 111 and the right side plate 112 are provided with outward flanges 1113, 1123. By arranging sealing strips at the flanges 1113, 1123 and interfacing them with the frame of the compartment, enhanced waterproofing, sound insulation, and heat insulation can be realized. A left end, a right end, and a lower end of the top plate 140 are further provided with inward flanges 145.

The operation process of the pullable-foldable combined rear expansion structure for recreational vehicles of the present disclosure is as follows:

To deploy the rear expansion structure, a fixing lock (not shown in the figures) between the top plate and the compartment is unlocked at first. Then, the second handle on the rear plate is pushed to slide the entire frame outwards along the static guide rails, during which, the top plate is pushed to turn over while unfolding the front bottom plate and the rear bottom plate. Once the frame slides to the limit position, the front bottom and the rear bottom plates are flattened, securing the rear expansion structure at its maximum extension. Furthermore, hinge pins on the rear plate are inserted into the corresponding holes on the top plate, so that it is impossible to further overturn the top plate or push back the rear expansion structure from the outside.

To retract the rear expansion structure, the first handle on the front bottom plate is pulled at first, so that the entire frame slides inwards along the static guide rails. After the entire frame slides by a certain distance, the second handle on the rear plate is pulled, so that the entire frame retreats to the limit position. In this case, the front bottom plate and the rear bottom plate are folded upwards, the top plate is overturned to be attached to the rear portion of the compartment. Finally, the top plate is locked to the compartment through the fixing lock.

In the description of the present disclosure, it should be noted that the orientation or position relations indicated by the terms “center”, “upper”, “lower”, “left”, “right”, “vertical”, “horizontal”, “internal”, “external”, etc. are based on the orientation or position relations shown in the accompanying drawings, are merely for facilitating the description of the present disclosure, rather than indicating or implying that the device or element referred to must have a particular orientation or be constructed and operated in a particular orientation, and thus cannot be interpreted as limiting the present disclosure. In addition, the terms “first” and “second” are merely for description, and cannot be interpreted as indicating or implying relative importance.

In the description of the present disclosure, it should be noted that the terms “mount”, “connect”, and “connection” should be understood in a broad sense, unless explicitly specified and defined otherwise. For example, they can denote a fixed connection, a detachable connection, a mechanical connection, an electrical connection, a direct connection, an indirect connection via an intermediate medium, or communication inside two elements. For those of ordinary skill in the art, the specific meanings of the above terms in the present disclosure can be understood according to specific circumstances.

The above embodiments merely illustrate the basic principles and characteristics of, and are not intended to limit the present disclosure. Various changes and modifications can also be made to the present disclosure without departing from its spirit and scope, and these changes and modifications fall within the claimed scope of protection of the present disclosure. The claimed scope of protection of the present disclosure is defined by the appended claims and their equivalents.

1. A pullable-foldable combined rear expansion structure for recreational vehicles, comprising: side plates, a rear plate, bottom plates, a top plate, and a guide rail, wherein the side plates comprise a left side plate and a right side plate, and the left side plate and the right side plate are connected to the rear plate, so as to form a rigid frame; the bottom plates comprise a front bottom plate and a rear bottom plate, a front end of the front bottom plate is rotatably connected to a bottom of a compartment, a rear end of the front bottom plate is rotatably connected to a front end of the rear bottom plate, and a rear end of the rear bottom plate is rotatably connected to the frame; and the frame is connected to the compartment through the guide rail, the top plate is positioned at an outer side of the frame, and an upper end of the top plate is rotatably connected to a top of the compartment.

2. The pullable-foldable combined rear expansion structure for recreational vehicles according to claim 1, wherein the guide rails comprise a static guide rail and a movable guide rail, the static guide rail is fixed to the compartment, while the movable guide rail is fixed to the frame and moves relative to the static guide rail, so that stretch and retraction of the frame are realized.

3. The pullable-foldable combined rear expansion structure for recreational vehicles according to claim 2, wherein the movable guide rails comprise bottoms of the side plates and overhanging portions extending along the bottoms of the side plates, i.e. a first movable guide rail and a second movable guide rail; and the static guide rails are fixed to the bottom of the compartment, and comprise a first static guide rail and a second static guide rail that are positioned at two sides, and upper portions of the first static guide rail and the second static guide rail are provided with openings allowing the side plates to pass therethrough.

4. The pullable-foldable combined rear expansion structure for recreational vehicles according to claim 3, wherein upper sides of front portions of the left side plate and the right side plate are provided with extension portions, i.e. a first extension portion and a second extension portion that protrude upwards from the side plates; and the first extension portion and the second extension portion abut against corresponding structures in the compartment in a case that the frame stretches out to an external limit position.

5. The pullable-foldable combined rear expansion structure for recreational vehicles according to claim 4, wherein the movable guide rails further comprise a middle movable guide rail positioned between the first movable guide rail and the second movable guide rail, and the middle movable guide rail is connected to a bottom of the rear plate; and the static guide rails further comprise a middle static guide rail positioned between the first static guide rail and the second static guide rail, and the middle static guide rail cooperates with the middle movable guide rail.

6. The pullable-foldable combined rear expansion structure for recreational vehicles according to claim 5, wherein two middle movable guide rails, i.e. a third movable guide rail and a fourth movable guide rail are provided, and two middle static guide rails, i.e. a third static guide rail and a fourth static guide rail are provided.

7. The pullable-foldable combined rear expansion structure for recreational vehicles according to claim 6, wherein the movable guide rails and the static guide rails are of square-tube structures, and upper portions of the square-tube structures of the first static guide rail and the second static guide rail are provided with the openings.

8. The pullable-foldable combined rear expansion structure for recreational vehicles according to claim 7, wherein rollers are mounted at end portions, away from the frame, of the movable guide rails, the rollers on the movable guide rails are in contact and cooperation with internal upper surfaces of the static guide rails, the compartment is provided with rollers below the movable guide rails, and external lower surfaces of the movable guide rails are in contact and cooperation with the rollers mounted on the compartment when the movable guide rails stretch or retract.

9. The pullable-foldable combined rear expansion structure for recreational vehicles according to claim 8, wherein a first connector is arranged at a position, close to the rear plate, of a bottom of the frame, and the first connector is connected to the first movable guide rail, the second movable guide rail, the third movable guide rail, and the fourth movable guide rail; and the static guide rails comprise a second connector close to a rear portion of the compartment, and the second connector is connected to the first static guide rail, the second static guide rail, the third static guide rail, and the fourth static guide rail.

10. The pullable-foldable combined rear expansion structure for recreational vehicles according to claim 9, wherein the front bottom plate and the rear bottom plate, the front bottom plate and the compartment, as well as the rear bottom plate and the frame are rotatably connected to each other through hinges respectively.

11. The pullable-foldable combined rear expansion structure for recreational vehicles according to claim 10, wherein one side of the hinge connecting the rear bottom plate and the frame is mounted on an upper surface of the first connector, and the other side is mounted on a rear end surface of the rear bottom plate; and one side of the hinge connecting the front bottom plate and the compartment is mounted on an upper surface of the second connector, and the other side is mounted on a front end surface of the front bottom plate.

12. The pullable-foldable combined rear expansion structure for recreational vehicles according to claim 11, wherein the static guide rails further comprise a third connector arranged parallel to the second connector, and the third connector is connected to the first static guide rail, the second static guide rail, the third static guide rail, and the fourth static guide rail.

13. The pullable-foldable combined rear expansion structure for recreational vehicles according to claim 1, wherein a first handle is provided at a position, close to the rear bottom plate, of a middle of the front bottom plate, and a window and a second handle are provided at a middle and an upper portion of the rear plate respectively.

14. The pullable-foldable combined rear expansion structure for recreational vehicles according to claim 13, wherein the first handle is hidden.

15. The pullable-foldable combined rear expansion structure for recreational vehicles according to claim 1, wherein upper portions of the left side plate and the right side plate are configured as of inclined structures relative to a horizontal plane, and upper sides of rear portions of the left side plate and the right side plate are provided with extension portions, i.e. a third extension portion and a fourth extension portion that protrude backwards from the side plates respectively; and the third extension portion and the fourth extension portion are provided with rolling portions respectively, and the rolling portions make contact with the top plate in a case that the frame stretches or retracts relative to the compartment.

16. The pullable-foldable combined rear expansion structure for recreational vehicles according to claim 15, wherein the top plate is provided with outward protrusion portions accommodating upper portions of the rolling portions in a case that the frame stretches to a limit position relative to the compartment.

17. The pullable-foldable combined rear expansion structure for recreational vehicles according to claim 1, wherein an inner side of the top plate is provided with a sealing portion, and an upper portion of the rear plate is further provided with a location pin; and the sealing portion covers an outer edge of an upper portion of the frame, and the location pin penetrates a corresponding hole on the sealing portion in a case that the frame stretches to a limit position relative to the compartment.

18. The pullable-foldable combined rear expansion structure for recreational vehicles according to claim 17, wherein the top plate is rotatably connected to the compartment through an adapter plate including parallel planes at two ends and a connecting plane in a middle; and one end of the adapter plate is fixedly connected to a rear portion of the compartment, and the other end is connected to an outward flange at the upper end of the top plate through a hinge.

19. The pullable-foldable combined rear expansion structure for recreational vehicles according to claim 1, wherein front portions of the left side plate and the right side plate are provided with outward flanges, and a left end, a right end, and a lower end of the top plate are provided with inward flanges.
